(19) United States
(12) Patent Application Publication
(10) Pub. No.: US 2015/0231429 A1
(43) Pub. Date: Aug. 20, 2015

(54) UNIDIRECTIONAL, SPRINKLER-TYPE, ANTIPERSONNEL-FRAGMENTATION-FREE FIRE-EXTINGUISHING BOMB

(71) Applicant: BEIJING MECHANICAL EQUIPMENT INSTITUTE, Beijing (CN)

(72) Inventors: Xiaodi Lin, Beijing (CN); Shuyong Han, Beijing (CN); Aifeng Chen, Beijing (CN); Hao Liu, Beijing (CN); Xuyang Qiu, Beijing (CN); Wen Ding, Beijing (CN); Hejiu Wang, Beijing (CN)

(73) Assignee: BEIJING MECHANICAL EQUIPMENT INSTITUTE, Beijing (CN)

(21) Appl. No.: 14/405,588

(22) PCT Filed: Jul. 12, 2013
(86) PCT No.: PCT/CN2013/079324

§ 371 Date: Dec. 4, 2014

(30) Foreign Application Priority Data
Aug. 2, 2012 (CN) 201210272992.4

(51) Int. Cl. A62C 19/00; F42B 12/46

(52) U.S. Cl. CPC A62C 19/00; F42B 12/46

(57) ABSTRACT

The invention discloses a unidirectional spray type fire extinguishing bomb without high explosive fragmentation, includes a housing, a fuse, an igniter, an fire extinguishing agent and a main charge, and further includes a tail braking device, combustor, a plate closure, a piston and a diffuser. The housing, the tail braking device and the piston are made of light metal materials; the housing is cylindrical; the tail braking device is arranged at the bottom of the housing and is fixed with the housing through a screw nail; and the fuse is arranged on the diffuser and is fixed through a screw nail. During working process, when the fuse detects the fire extinguishing bomb to be 5-10 meters far away from a combustion source, the igniter ignites the main charge, the piston is pushed under high pressure to move in the housing, and the fire extinguishing agent is sprayed out from spraying holes to the combustion source for fire extinguishing. The present invention has simple structure, and has no lethality when the fire extinguishing agent is sprayed.

### TECHNICAL FIELD

The present invention relates to a fire extinguishing bomb, especially to a unidirectional spray type fire extinguishing bomb without high explosive fragmentation.

### BACKGROUND

At present, the existing fire extinguishing bombs at home and abroad all take the manner of tube bursting in the middle. In general, the existing fire extinguishing bomb includes a housing, a fuse, a fire extinguishing agent, a main charge, and an igniter; the fire extinguishing agent is pushed to spray by the shock wave produced during the explosion; a lot of high explosive fragmentations with a certain destructive effect are produced while spraying the fire extinguishing agent; this kind of fire extinguishing bombs are suitable for forests, oil tanks, etc. that are far away from densely populated areas, but are not suitable for the fire extinguishing of high-rise buildings and super high-rise buildings under the condition of urban environment.

### SUMMARY

The object of the present invention is to provide a unidirectional spray type fire extinguishing bomb without high explosive fragmentation to address the problem that the existing fire extinguishing bombs have high explosive fragmentations and are easy to cause big damage.

A unidirectional spray type fire extinguishing bomb without high explosive fragmentation, includes a housing, a fuse, an igniter, a fire extinguishing agent and a main charge, and further includes a tail braking device, combustor, a plate closure, a piston and a diffuser.

The housing, the tail braking device and the piston are made of light metal materials; the housing is cylindrical; the tail braking device is arranged at the bottom of the housing and is fixed with the housing through a screw nail; the plate closure is arranged above the tail braking device; the combustor is arranged above the plate closure and is fixed with the plate closure screwedly; the combustor is fixed with the housing via a screw nail; the piston is arranged on the combustor; the outer diameter of the piston mates with the inner diameter of the housing; the piston has a through hole at the center; the igniter is arranged within the through hole of the piston and is fixed with the combustor screwedly; the main charge is arranged within the combustor; the fire extinguishing agent is arranged within the cavity on the upper portion of the piston and fills up the entire cavity; the diffuser is arranged at the top of the housing and is fixed with the housing through a screw nail; the diffuser has spraying holes on the surface; and the fuse is arranged on the diffuser and is fixed through a screw nail.

During working process of a unidirectional spray type fire extinguishing bomb without high explosive fragmentation, when the fuse detects that the fire extinguishing bomb is 5-10 meters far away from a combustion source, it sends an ignition signal to the igniter, then the igniter ignites the main charge within the combustor, the main charge generates high pressure when combusting, the piston is pushed under high pressure to move in the housing, the extrusion to the fire extinguishing agent causes a pin connected between the diffuser and the housing to be sheared, the fire extinguishing agent continues to push the diffuser to move forward, the diffuser is braked when reaching the front end of the housing, at that time the spraying holes have already been exposed to the air, while then the piston continues to push the fire extinguishing agent to move forward, the fire extinguishing agent is sprayed out from the spraying holes to the combustion source for fire extinguishing. During the flight spraying process of the fire extinguishing bomb, the tail braking device opens a parachute to make the fire extinguishing bomb decelerate, the fire extinguishing bomb penetrates the glass curtain wall, and goes deep into the building to implement fire extinguishing.

The apparatus of the present invention has simple structure, has no lethality when the fire extinguishing agent is sprayed. And it is suitable for fire extinguishing of high-rise buildings, and also can be used for putting out a fire on the facade of the high-rise buildings.

### BRIEF DESCRIPTION OF THE DRAWINGS

FIG. 1 is a schematic diagram of a unidirectional spray type fire extinguishing bomb without high explosive fragmentation.

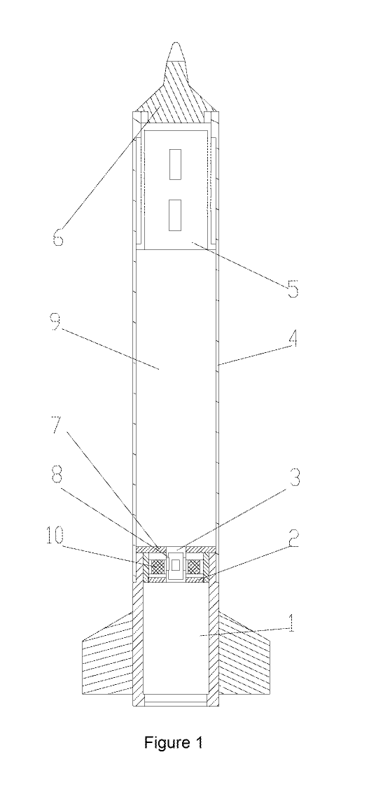

1. tail braking device 2. plate closure 3. igniter 4. housing 5. diffuser 6. fuse 7. piston 8. combustor 9. fire extinguishing agent 10. main charge

### DETAILED DESCRIPTION

A unidirectional spray type fire extinguishing bomb without high explosive fragmentation includes a housing 4, a fuse 6, an igniter 3, a fire extinguishing agent 9 and a main charge 10, and further includes a tail braking device 1, combustor 8, a plate closure 2, a piston 7 and a diffuser 5.

The housing 4, the tail braking device 1 and the piston 7 are made of light metal materials; the housing 4 is cylindrical; the tail braking device 1 is arranged at the bottom of the housing 4 and is fixed with the housing 4 through a screw nail; the plate closure 2 is arranged above the tail braking device 1; the combustor 8 is arranged above the plate closure 2 and is fixed with the plate closure 2 screwedly; the combustor 8 is fixed with the housing 4 via a screw nail; the piston 7 is arranged on the combustor 8; the outer diameter of the piston 7 mates with the inner diameter of the housing 4; the piston 7 has a through hole at the center; the igniter 3 is arranged within the through hole of the piston 7 and is fixed with the combustor 8 screwedly; the main charge 10 is arranged within the combustor 8; the fire extinguishing agent 9 is arranged within the cavity on the upper portion of the piston 7 and fills up the entire cavity; the diffuser 5 is arranged at the top of the housing 4 and is fixed with the housing 4 through a screw nail; the diffuser 5 has spraying holes on the surface; and the fuse 6 is arranged on the diffuser 5 and is fixed through a screw nail;

During working process of a unidirectional spray type fire extinguishing bomb without high explosive fragmentation, when the fuse 6 detects the fire extinguishing bomb to be 5-10 meters far away from a combustion source, it sends an ignition signal to the igniter 3, the igniter 3 ignites the main charge 10 within the combustor 8, the main charge 10 generates high pressure when combusting, the piston 7 is pushed under high pressure to move in the housing 4, the extrusion to the fire extinguishing agent 9 causes a pin connected between the diffuser 5 and the housing 4 to be sheared, the fire extinguishing agent 9 continues to push the diffuser 5 to move forward, the diffuser 5 is braked when reaching the front end of the housing 4, at that time the spraying holes have already been exposed to the air, while then the piston 7 continues to push the fire extinguishing agent 9 to move forward, the fire extinguishing agent 9 is sprayed out from the spraying holes to the combustion source for fire extinguishing; during the flight spraying process of the fire extinguishing bomb, the tail braking device 1 opens a parachute to make the fire extinguishing bomb decelerate, the fire extinguishing bomb penetrates the glass curtain wall, and goes deep into the building to implement fire extinguishing.

1. (canceled)

2. A unidirectional spray type fire extinguishing bomb, comprising:
a cylindrical housing defining a cavity thereto,
a tail braking device disposed at the bottom of the housing and coupled with the housing by a fastener,
a plate closure disposed above the tail braking device,
a combustor disposed above the plate closure and coupled with the plate closure by a threaded connection, and coupled with the housing by a fastener,
a piston disposed substantially above the combustor and defining a through hole at a center,
an igniter disposed within the through hole of the piston and coupled with the combustor by a threaded connection,
a main charge disposed within the combustor,
a fire extinguishing agent disposed substantially above the piston and substantially filling the cavity of the housing,
a diffuser disposed at the top of the housing and coupled with the housing by a fastener, and
a fuse disposed on the diffuser and coupled with the diffuser by a fastener.

3. The fire extinguishing bomb of claim 2 wherein the outer diameter of the piston substantially matches the inner diameter of the housing.

4. The fire extinguishing bomb of claim 2 wherein the diffuser has spraying holes disposed on its surface.

5. The fire extinguishing bomb of claim 2 wherein the fastener is a screw nail.

6. The fire extinguishing bomb of claim 2 wherein the fuse is configured to transmit an ignite signal to the igniter when the fuse detects that the fire extinguishing bomb is about 5 to about 10 meters from a combustion source.

7. The fire extinguishing bomb of claim 2 wherein the housing, the tail braking device, and the piston are made of light metal materials.
